(19) United States
(12) Patent Application Publication
(10) Pub. No.: US 2022/0185603 A1
(43) Pub. Date: Jun. 16, 2022

(54) Systems and Methods Related to Transfer Sampling of Particle Mixtures

(71) Applicant: Charles A. Statton, Orfordville, WI (US)

(72) Inventor: Charles A. Statton, Orfordville, WI (US)

(21) Appl. No.: 17/550,068

(22) Filed: Dec. 14, 2021

Related U.S. Application Data
(60) Provisional application No. 63/125,001, filed on Dec. 14, 2020.
(60) Provisional application No. 63/242,791, filed on Sep. 10, 2021.

(51) Int. Cl. B65G 65/40; B66F 9/02

(52) U.S. Cl. CPC B65G 65/40; B66F 9/02

(57) ABSTRACT

Systems and methods for sampling particle mixtures include use of a cantilevered arm and sample collector to extend into a particle mixture cascade or stream to capture a sample of the mixture for analysis, audit, certification, or review. Generally, the arm is rotatable about a vertical axis and extendable in a radial direction therefrom at a selectable height. The sample collector is in the form of a gimballed cup disposed at a free end of the cantilevered arm.

### BACKGROUND OF THE INVENTION

At animal feed mills or mills producing or conveying some other bulk particle mixture product, it is common for particle mixtures to be transferred into bulk commodity trailers and other storage vessels for the purpose of transporting the particle mixture from the mill to customers, for example. Ordinarily, the particle mixture is stored in an elevated hopper. The hopper is elevated at a sufficient height to permit a delivery truck to be positioned at least partially vertically beneath the hopper for the purpose of accepting a particle mixture deposit from the hopper. Typically, some space exists between the top of the delivery truck and the bottom of the hopper during this transfer process.

To ensure that particle mixture of a satisfactory quality and composition is being deposited into delivery trucks, it is common practice to obtain a small sample of the particle mixture during the time the mixture is being transferred from hopper to container or truck. This has previously been often achieved by manually obtaining a sample by introducing a handheld mechanism into the space between the top of the delivery truck and the bottom of the hopper during the transfer. The manual and handheld nature of the process required an individual to climb up a potentially slippery ladder on a delivery truck, move along the top of the delivery truck, and approach the bottom of the hopper. This creates a dangerous scenario for a number of reasons: the individual could slip while scaling the truck ladder, the individual could fall from the top of the truck, the individual could strike his or her head on the underside of the hopper, the individual could injure a limb whilst reaching to obtain a sample, or the individual or an individual's limb could become trapped within the bulk commodity trailer underneath a heavy load of particle mixture.

The above-listed safety concerns create a need for an improvement to particle mixture sampling methods. In particular, there is a need for a system to sample a particle mixture remotely and preferably automatically during the transfer of said particle mixture from the hopper into the delivery truck.

### SUMMARY OF THE INVENTION

Systems and methods according to the present invention provide improvements to the art, enabling safer mixture sampling practices. Generally, a system according to the present invention includes a body assembly having a top member including an arm mount and a lower member supporting the top member. An arm assembly extends radially outwardly from the top member, the arm assembly having a linearly variable arm length, a first end coupled to the arm mount, a second end supporting a cup supported proximate the second end. A controller is configured to vary the arm length.

According to an aspect of an embodiment of a system according to the present invention, the top member is rotatable about a body axis, the rotation being preferably controllable by the controller or a second controller.

According to another aspect of an embodiment of a system according to the present invention, the cup is gimballed with respect to the arm assembly.

A method according to the present invention includes the steps of positioning a cup in a stream of material being transferred from one receptacle to another, collecting a sample of the material in the cup, and mechanically translating the cup out of the stream of material.

According to an aspect of an embodiment of a method according to the present invention, the positioning step includes the step of extending an arm assembly from a retracted position to an extended position, the cup being supported by the arm assembly, such as by being gimballed with respect thereto.

### BRIEF DESCRIPTION OF THE DRAWINGS

FIG. 1 is a front view of a sampling system.

FIG. 2 is a left side elevation view of a body assembly, base assembly, and wall brace assembly of the sampling system of FIG. 1.

FIG. 3 is a left side elevation view of a first embodiment of a rotation assembly of the sampling system of FIG. 1.

FIG. 4 is a left side elevation view an extension arm assembly of the sampling system of FIG. 1.

FIG. 5 is a left side elevation view of the sampling system of FIG. 1 in a first position.

FIG. 6 is a left side elevation view of the sampling system of FIG. 1 in a second position.

FIG. 7 is an elevation view of an alternative embodiment of a rotation assembly for a sampling system according to the present invention.

FIG. 8A is a top plan view of the embodiment of FIG. 7 in a first rotational position.

FIG. 8B is a top plan view of the embodiment of FIG. 8 in a second rotational position.

### DESCRIPTION OF THE PREFERRED EMBODIMENT

Although the disclosure hereof enables those skilled in the art to practice the invention, the embodiments described merely exemplify the invention which may be embodied in other ways. While the preferred embodiment has been described, the details may be changed without departing form the invention, which is defined by the claims.

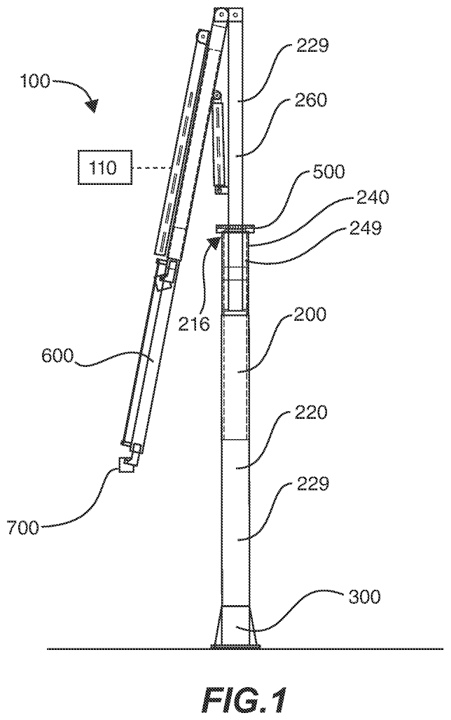

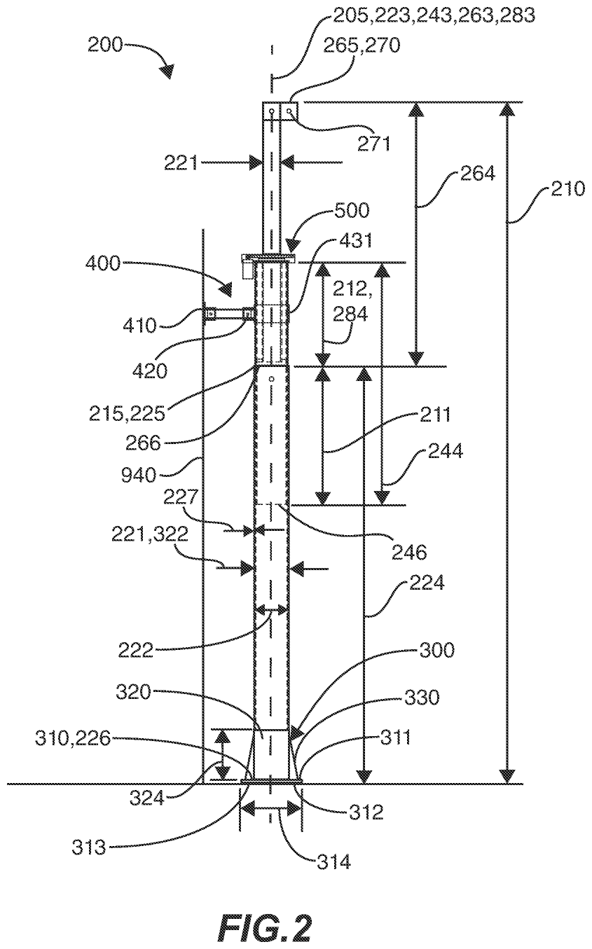

Turning now to the figures, FIGS. 1 and 2 show an embodiment of a particle mixture transfer sampling system 100 is shown. The sampling system 100 may include a body assembly 200, a base assembly 300, a wall brace assembly 400, rotation assembly 500, an extension arm assembly 600, and a cup assembly 700. Furthermore, the sampling system 100 may be coupled to an electrical power source, a pneumatic power source, and/or a hydraulic power source (not shown).

The sampling system 100 according to the present invention may obtain a sample of a particle mixture, such as when the particle mixture is being transferred or conveyed from one vessel to another. In particular, the sampling system 100 may be used to collect a sample of a particle mixture such as animal feed as it is being transferred from a hopper into a separate vessel such as into a bulk commodity trailer of a transport truck, at a time that may be random, periodic, and/or at a predetermined or selectable time during). As is described in detail below, the sampling system 100 is configured to permit such sampling to be taken safely (i.e. from a safe distance away from the transport truck and particle mixture hopper).

According to an exemplary embodiment, the power source may be comprised as a hydraulic, electrohydraulic, pneumatic, and/or electric system. When comprised as a hydraulic system, the power source may further include a plurality of hydraulic lines, a hydraulic pump, a reservoir, and one or more valves. The one or more control valves are configured to direct the pressurized hydraulic fluid for the purpose of controlling a hydraulic device, such as one or more hydraulic cylinder(s) or a hydraulic motor. The control valves may further include a controller 110 (which may be or include a handheld controller). While the present invention is described with reference to a hydraulic system, it is contemplated that some other power source (e.g., electric) may be used to operate the sampling system described herein.

The controller 110 may be a programmable logic controller (“PLC”) programmed to perform a plurality of functions associated with the sampling system 100. According to an exemplary embodiment the controller 110 may command the operation of each of the plurality of functions in a predetermined sequence. For example, the controller 110 may be programmed to perform the following sequence: (1) rotate the motor; (2) raise the extension arm; (3) extend the extension arm; (4) retract the extension arm; (5) lower the extension arm assembly; and (6) rotate the motor. In such an embodiment, controller 110 may have a button, switch, etc. that may be activated, where said activation commands the performance of the entire predetermined sequence. In other embodiments, each of the steps of the predetermined sequence may be performed independently by the activation of a plurality of buttons, switches, etc.

The body assembly 200 of the sampling system 100 may include a plurality of pedestal tubes including a first pedestal tube 220, a second pedestal tube 240, and a third pedestal tube 260. According to an exemplary embodiment, the first, second, and third pedestal tubes 220, 240, and 260 are preferably at least substantially hollow tubes having a square or circular cross-sectional shape, each tube having the same shape cross-section. However, in other embodiments, one or more of the pedestal tubes 220, 240, 260 may be a solid tubular member. As is described in detail below, exemplary embodiments are configured to permit the various pedestal tubes 220, 240, 260 to translate with respect to each other in a telescoping fashion (e.g., the second pedestal tube 240 slidably disposed with respect to or along the first pedestal tube 220). Likewise, the pedestal tubes 220, 240, 260 may also be configured with a rectangular, triangular, or some other cross-sectional shape. While the discussion of the present invention is primarily made with respect to hollow pedestal tubes 220, 240, 260 having a square or circular cross-sectional shape, the invention need not be so limited.

The first pedestal tube 220 may further include a first pedestal tube outer width 221, a first pedestal tube inner width 222, a first pedestal tube axis 223, a first pedestal tube length 224, a first pedestal tube top 225, a first pedestal tube bottom 226, a first pedestal tube thickness 227, a first pedestal tube outer surface 229, a cross section of which defines a first pedestal tube footprint area. The first pedestal tube thickness 227 is defined by the difference between the first pedestal tube outer width 221 and inner width 222, and is generally defined by the gauge of material used to make the first pedestal tube 220. The first pedestal tube 220 may also include a hollow core 228, where the hollow core 228 is bounded by the inner width 222. The footprint area, on the other hand, is equal to the area defined by the outer width 221 (including the hollow core 228). According to an exemplary embodiment, the first pedestal tube 220 preferably has a substantially square cross-sectional shape.

Likewise, the second pedestal tube 240 may include a second pedestal tube outer width 241, a second pedestal tube inner width 242, a second pedestal tube axis 243, a second pedestal tube length 244, a second pedestal tube top 245, a second pedestal tube bottom 246, and a second pedestal tube thickness 247. The second pedestal tube thickness 247 is defined by the difference between the second pedestal tube outer width 241 and the second pedestal tube inner width 242. Like the first pedestal tube 220, the second pedestal tube 240 may also include a hollow core 248 where the hollow core 248 is defined by the inner width 242. According to an exemplary embodiment, the second pedestal tube 240 preferably has a square cross-sectional shape.

Finally, the third pedestal tube 260 may also include a third pedestal tube outer diameter 261, a third pedestal tube inner diameter 262, a third pedestal tube axis 263, a third pedestal tube length 264, a third pedestal tube top 265, a third pedestal tube bottom 266, and a third pedestal tube thickness 267. The third pedestal tube thickness 267 is defined by the difference between the third pedestal tube outer diameter 261 and the third pedestal tube inner diameter 262. The third pedestal tube 260 may optionally include a hollow core 268 where the hollow core 268 is defined by the inner diameter 262. According to an exemplary embodiment, the third pedestal tube 260 preferably has a circular cross-sectional shape.

Each of the first, second, and third pedestal tubes 220, 240, 260 preferably has a pedestal tube thickness 227, 247, 267 of approximately ¼ inch (0.25 inches). Moreover, the first pedestal tube 220 preferably has an inner width 222 that is greater than the outer width 241 of the second pedestal tube 240. Furthermore, the second pedestal tube inner width 242 is preferably greater than the outer diameter 261 of the third pedestal tube 260. In such a configuration, the second pedestal tube 240 may be received by the first pedestal tube 220. Likewise, the third pedestal tube 260 may be received by the second pedestal tube 240 (and thus the third pedestal tube 260 may also be received by the first pedestal tube 220). This configuration permits the various pedestal tubes 220, 240, 260 to be arranged in a telescoping fashion with each of the axes 223, 243, 263 being substantially coaxial. The axes 223, 243, 263 together define a body axis 205. According to an exemplary embodiment, the outer width 221 of the first pedestal tube 220 may be about eight inches (8″). In exemplary embodiments, the outer width 241 of the second pedestal tube 240 may be about seven and one-half inches (7.5″). The outer diameter 261 of the third pedestal tube 260 may be about four inches (4″) according to an exemplary embodiment.

While the pedestal tubes 220, 240, 260 may be arranged in a telescoping fashion, preferred embodiments may include pedestal tubes 220, 240, 260 that are not slidably coupled. In other words, the pedestal tubes 220, 240, 260 need not be coupled in a fashion that permits one or more of the pedestal tubes 220, 240, 260 to slide or translate; the pedestal tubes 220, 240, 260 may instead be mated in a fixed (either removably fixed, such as with pins, bolts/nuts, etc., or permanently fixed, such as by welding) fashion such that the pedestal tubes 220, 240, 260 do not slide or translate. Moreover, the entire length 244 of the second pedestal tube 240 need not be disposed within the first pedestal tube 220, according to an exemplary embodiment. In the same way, the entire length 264 of the third pedestal tube 260 need not be disposed within the second pedestal tube 240 and/or the first pedestal tube 220. Rather, the second pedestal tube 240 may be inserted into the first pedestal tube 220 at a first telescoping depth 211, and the third pedestal tube 260 may be inserted into the second pedestal tube 240 at a second telescoping depth 212.

According to an exemplary embodiment, the second pedestal tube 240 may not slidably translate along the body axis 205 when mounted within the first pedestal tube 220. Rather, the second pedestal tube 240 may be mated to the first pedestal tube 220 at a fixed first telescoping depth 211. In an exemplary embodiment, the second pedestal tube 240 may be mounted within the first pedestal tube 220 via a shank-style fastener (e.g. hex bolt). Specifically, the first pedestal tube 220 and the second pedestal tube 240 may each one or more apertures 230, 250 that, when the second pedestal tube 240 is inserted within the first pedestal tube 220 become substantially concentric at the first telescoping depth 211 as to permit the insertion of the shank-style fastener, for example.

Similarly, the third pedestal tube 260 is not configured to translate longitudinally along the body axis 205 when mounted within the second pedestal tube 240. Rather, the third pedestal tube 260 may be coupled to the second pedestal tube 240 at a fixed second telescoping depth 212. According to an exemplary embodiment, the third pedestal tube 260 preferably rotates at least partially about the body axis 205, as described in detail below.

To keep the third pedestal tube 260 secure within the second pedestal tube 240 whilst permitting rotation about the body axis 205, a support sleeve 280 may be used. The support sleeve 280 may include an outer diameter 281, an inner diameter 282, an axis 283, a length 284, a top 285, a bottom 286, and a thickness 287. The thickness 287 of the support sleeve 280 is defined by the difference between the outer diameter 281 and the inner diameter 282. The support sleeve axis 283 is preferably coaxial with or parallel to the body axis 205 (and thus with or to the third pedestal tube axis 263 as well). The length 284 of the support sleeve 280 may preferably be approximately equivalent to the second telescoping depth 212 or slightly shorter.

According to an exemplary embodiment, the support sleeve 280 may be inserted into the second pedestal tube 240 such that the top 285 of the support sleeve 280 is proximate to the top 245 of the second pedestal tube 240. In such a preferred embodiment, the inner diameter 281 of the support sleeve 280 may be slightly larger than the outer diameter 261 of the third pedestal tube 260 in order to permit the third pedestal tube 260 to be inserted within the support sleeve 280. Accordingly, the third pedestal tube 260 is configured to be inserted into the support sleeve 280, which is then inserted into the second pedestal tube 240. The support sleeve 280 may be mounted within the second pedestal tube 240 by welding or some other operation to fix it relative thereto. For example, the support sleeve 280 may further include a plate 288 or one or more tabs 289 that may then be welded within the second pedestal tube 240.

The sampling system 100 may thus have a pedestal height 210 which is defined by the cumulative height of the nested or otherwise assembled pedestal tubes 220, 240, 260 after the second pedestal tube 240 has been mated to the first pedestal tube 220 as a first telescoping depth 211 and after the third pedestal tube 260 has been coupled to the second pedestal tube 240 at a second telescoping depth 212.

When the pedestal tubes 220, 240, 260 are coupled together (i.e. when the second pedestal tube 240 is inserted into and mated to the first pedestal tube 220 at a first telescoping depth 211 and when the third pedestal tube 260 is inserted into and mated to the second pedestal tube 240 at a second telescoping depth 212), a first telescoping joint 215 and a second telescoping joint 216 are created. The first telescoping joint 215 is defined by the top 225 of the first pedestal tube 220 after the second pedestal tube 240 is coupled to the first pedestal tube 220. At this joint 215, the first pedestal tube 220 ends while the body assembly 200 continues along the body axis 205 via the second pedestal tube 240. Likewise, the second telescoping joint 216 is defined by the top 245 of the second pedestal tube 240. At this joint 216, the second pedestal tube 240 ends while the body assembly 200 continues along the body axis 205 via the third pedestal tube 260.

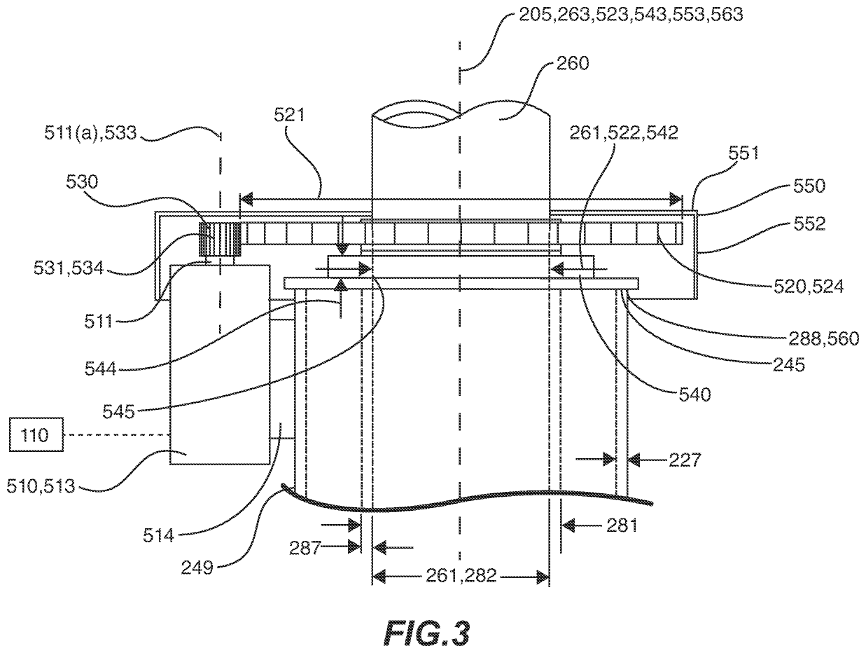

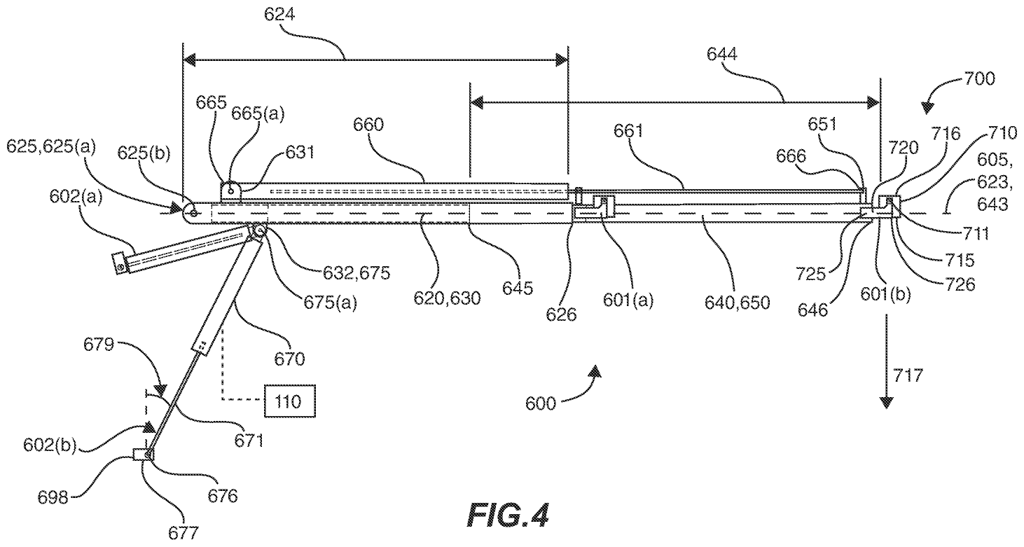

While the third pedestal tube 260 may not be configured to translate along the body axis 205, the third pedestal tube 260 may be configured to rotate at least partially about the body axis 205 (preferably through at least ninety degrees, and more preferably through at least one hundred and eighty degrees) according to an exemplary embodiment. Specifically, the sampling system 100 may include a rotation assembly 500 (described more fully in connection with FIG. 3) configured to rotate the third pedestal tube 260 about the body axis 205, as is described in detail below with reference to FIG. 4.

The third pedestal tube 260 is also coupled to the extension arm assembly 600, as is shown in FIG. 1 and described below in detail with reference to FIG. 4. To facilitate such coupling, the top 265 of the third pedestal tube 260 may include an extension arm fixture 270. The extension arm fixture 270 may also include at least one extension arm aperture 271, wherein the extension arm aperture 271 is formed along an extension arm aperture axis.

According to an exemplary embodiment, the base assembly 300 may include a pedestal plate 310 and a plurality of pedestal bracing members 330. The pedestal plate 310 may be configured as a plate-like structure having a pedestal plate top 311, a pedestal plate bottom 312, and a rectangular, circular, or other shape. According to an exemplary embodiment, the pedestal plate 310 may have a length 314 and a square cross-sectional shape, thus defining a footprint area equal the length 314 squared (e.g., 196 square inches in embodiments featuring a length 314 of fourteen inches). The pedestal plate 310 is preferably configured to lie on a ground surface for the purpose of supporting the weight of the sampling system 100. Specifically, the bottom 312 of the pedestal plate 310 may be configured to rest on the ground surface. The ground (or other support) surface on which the pedestal plate 310 lies may be concrete or some other material (e.g. gravel). In any case, the pedestal plate 310 may preferably be configured to have a pedestal plate footprint area that is larger than the footprint area of the first pedestal tube 220. In this way, the weight of the sampling system 100 is better-distributed through the pedestal plate 310 to reduce stress concentration.

To further support the sampling system 100, the pedestal plate 310 may also include a plurality of anchoring apertures extending through the plate 310 for the purpose of anchoring the plate 310 to the ground surface. Each anchoring aperture may accept a fastener for the purposes of fastening the pedestal plate 310 to the ground. For example, the shank of one or more fasteners (e.g. bolt or spike) may be inserted through the anchoring apertures and into the ground.

The first pedestal tube 220 (which may subsequently coupled to the second pedestal tube 240, which may itself be coupled to the third pedestal tube 260 as described above) may be mounted to the pedestal plate 310, specifically to the top 311 of the pedestal plate 310. The bottom 226 of the first pedestal tube 220 may be mounted to the pedestal plate 310 via welding around a perimeter of the first pedestal tube 220 (i.e. the border defined by the outer width 221) at the bottom 226 of said pedestal tube 220.

The base assembly 300 may also include a base tube 320, according to an exemplary embodiment, configured to receive, be coupled to, or be formed as an extension of the first pedestal tube 220. The base tube 320 preferably has a base tube outer width 321, a base tube inner width 322, base tube length 324. In this embodiment, the inner width 322 of the base tube 320 may be approximately equal to the outer width 221 of the first pedestal tube 220 such that the first pedestal tube 220 may be inserted into the base tube 320.

Additionally or alternatively, the base assembly 300 may include one or more mounting brackets (not shown), wherein the mounting brackets coupled to both the pedestal plate 310 and the first pedestal tube outer surface 229 for the purpose of securing coupling the first pedestal tube 220 and the pedestal plate 310 together. The brackets may be configured in an L-shape, having a bottom face and a side face, where the side face is substantially perpendicular to the bottom face. The bottom face may mate to the pedestal plate 310, while the side face may mate to the outer surface 229 of the first pedestal tube 220. To mate the bracket to both the pedestal plate 310 and first pedestal tube 220, the bracket may further include bracket apertures in order to permit the use of fasteners (e.g., bolt and nut fasteners). According to an exemplary embodiment having a first pedestal tube 220 with a square cross-sectional shape, four brackets may be used to secure the pedestal tube 220 to the pedestal plate 310.

Additionally or alternatively, the base assembly 300 may include a plurality of pedestal bracing members 330. The pedestal bracing members 330 may be configured as gusset structures mounted to the outer surface 229 of the first pedestal tube 220 and the top face 311 of the pedestal plate 310. According to exemplary embodiments, the bracing members 330 are preferably formed as substantially triangular gussets. The pedestal bracing members 330 may be used to enhance the structural rigidity of the sampling system 100.

In other embodiments, the base assembly 300 may include structure (not shown) to allow translation of the system 100 along a horizontal support surface, such as a floor or the ground, including a plurality of wheels. Such embodiments may include wheels that are configured to permit the sampling system 100 to move along the ground in order to position said sampling system 100 according to one's needs, which may be desirable in circumstances where multiple particle mixtures in a plurality of locations might need to be sampled. The movable base may further include a chassis body, a chassis bottom surface, and a chassis upper surface. The chassis bottom surface may further include a plurality of wheel mounting means where such mounting means may be comprised as threaded holes (i.e. an aperture with internal threads) configured to accept a bolt or other fastener (i.e. a male threaded shank). The wheels of the movable base assembly may be configured as casters or similar wheel mechanisms that are coupled to the chassis bottom surface via the wheel mounting means. The wheels may preferably be configured with a locking mechanism so as to prevent the wheels from rotating once the sampling system 100 has been moved into a desirable location.

In other embodiments, the wheels may be mounted on the top face 311 of the pedestal plate 310, where the pedestal plate 310 further includes a plurality of edges 313 (i.e. four edges 313 in embodiments where the pedestal plate 310 takes a square or rectangular cross-sectional shape). In such embodiments, each wheel may further include a wheel axis about which the respective wheel rotates. The wheels may be mounted on the top face 311 of the pedestal plate 310 proximate to one or more of the edges 313 such that the wheel axis is substantially aligned with the edge 313 of the pedestal plate 310. In this way, the wheel will be positioned partially over the edge 313 of the pedestal plate. When the pedestal plate (and body assembly 200) is tipped, however, the wheel(s) will come into contact with the ground surface, thereby permitting the sampling system 100 to be temporarily movable. According to exemplary embodiments, the wheels come into contact with the ground surface, thereby making the sampling system 100 movable, if the body assembly 200 and pedestal plate 310 are tipped approximately twenty degrees (20°) from a substantially vertical position of the body assembly 200.

Referring now to FIG. 2, a sampling system 100 may include a brace assembly 400. Though the base assembly 300 is configured to provide vertical and some horizontal support for the sampling system 100, the brace assembly 400 may also be used to provide additional support (especially horizontal or anti-tipping support) for the sampling system 100. The brace assembly 400 generally includes some combination of braces, brackets, trusswork, etc. extending from a first end 410 to a second end 420. The first end 410 is preferably fixedly coupled to a building wall or other support structure and the second end 420 is preferably fixedly coupled to the body assembly 200. The brace assembly 400 may be constructed of materials sufficiently rigid to maintain a generally upright configuration of the body assembly 200 during use, such materials including wood, metal, plastic, cable/rope, etc.

Referring now to FIG. 3, the rotation assembly 500 may include a motor 510 (e.g., hydraulic or electric), a ring gear 520, a spur gear 530, a bearing 540, a gear cover 550 a pedestal top 560, and a motor mounting means 570. As described above, the third pedestal tube 260 may be mounted within the second pedestal tube 240 yet remain free to rotate at least partially about the body axis 205. To facilitate the rotation about the body axis 205, the bearing 540 preferably has a bearing inner diameter 542, a bearing axis 543, a bearing thickness 544, and a bearing inner surface 545. The bearing 540 preferably reduces friction as the third pedestal tube 260 rotates within the second pedestal tube 240. Furthermore, the bearing 540 preferably assists in maintaining coaxial alignment between the third pedestal tube axis 263 and the first and second pedestal tube axes 223, 243, which in turn ensures that the third pedestal tube 260 rotates about the body axis 205. The third pedestal tube 260 may further include an outer surface 269 to which a movable portion of the bearing 240 is configured to mate. Specifically, the bearing inner diameter 542 may be substantially equal to the third pedestal tube outer diameter 261 such that the bearing inner surface 545 is in contact with the outer surface 269 of the third pedestal tube 260 over the entire bearing thickness 544. While the bearing 540 may be constructed as a plain bearing, a rolling element bearing (e.g., roller bearing, ball bearing, thrust bearing, or plate bearing) is preferable.

To facilitate rotation of the ring gear 520 (which is secured to third pedestal 260) and thus the rotation of the third pedestal tube 260, the rotation assembly 500 may further include a motor 510 (which may be electric or hydraulic). The motor 510 preferably includes a drive shaft 511 supporting, and capable of rotating, the spur gear 530 in two directions. In some embodiments, the spur gear 530 may be formed on the shaft 511 itself (i.e., integrally therewith), thus obviating the need to engage the shaft 511 and a separate spur gear 530. In other embodiments, the spur gear 530 may have a hub secured to the shaft 511. The hub may be smooth, fluted, or keyed.

For example, the shaft 511 of the motor 510 may be configured as a substantially smooth cylindrical shaft with a keyed end. The keyed end is configured to engage with the hub. Alternatively, the shaft 511 may be a fluted shaft, having a plurality of teeth/grooves adapted to engage with inner flutes of the hub. In either configuration, the shaft 511 is configured to engage with the spur gear 530 such that the rotation of the shaft 511 causes a corresponding rotation of the spur gear 530 about a spur gear axis 533. Moreover, a single rotation of the shaft 511 preferably causes a single rotation of the spur gear 533.

The spur gear 530 preferably directly engages the ring gear 520, though indirect engagement is contemplated (e.g., belt or chain drive). In particular, the spur gear 530 may have a plurality of spur gear teeth 534 disposed on an outer surface 531 of the spur gear 530. Similarly, the ring gear 520 may have a plurality of ring gear teeth 524 disposed on an outer diameter 521 of the ring gear 520. The spur gear teeth 334 mesh with the ring gear teeth 324 such that the rotation of the spur gear 530 may cause the rotation of the ring gear 520 when the spur gear 530 and ring gear 520 are engaged, and the spur gear 530 is rotated by the motor 510. According to an exemplary embodiment, the spur gear 530 is preferably smaller than the ring gear 520 such that a full rotation (i.e. 360° rotation) of the spur gear 530 causes less than a full rotation (i.e. <360° rotation) of the ring gear 520. For example, a gear ratio of 20:1 or 50:1 may be used, where twenty or fifty rotations, respectively, of the spur gear 530 result in one rotation of the ring gear 520.

Finally, the ring gear 520 may further include a ring gear inner diameter 522 and a ring gear axis 523. The ring gear 520 is preferably fixedly coupled to the third pedestal tube 260. Specifically, the inner diameter 522 of the ring gear 520 may be coupled around the outer diameter 261 of the third pedestal tube 260 where the third pedestal tube 260 has a circular cross-sectional shape. In such an embodiment, the ring gear axis 523 is preferably coaxial with the third pedestal tube axis 263 and thus with the body axis 205. The ring gear 520 may be mated to the third pedestal tube 260 by some permanent mating means (e.g. welding) or via some temporary mating means (e.g. fasteners, key/flute, or press-fitting). By mating the ring gear 520 to the third pedestal tube 260, the rotation of the ring gear 520 results in an equal rotation of the third pedestal tube 260 about the body axis 205. For example, rotating the ring gear 520 by ninety degrees (90°) also rotates the third pedestal tube 260 by ninety degrees) (90°).

The motor 510 may be mounted to the second pedestal tube 240 (or even mounted to a separate support structure). Specifically, the motor 510 may be mounted proximate to the top 245 of the second pedestal tube 240 (i.e. proximate to the joint 216 created by the mating of the second pedestal tube 240 and the third pedestal tube 260). For example, the motor 510 may include a motor body 513, where the motor body 513 may further include one or more motor body mounting means 514, which is preferably secured to the second pedestal tube 240, or other support structure, such as by welding and/or with threaded fasteners.

The rotation assembly 500, specifically the bearing 540, may be mounted to a pedestal top 560. The pedestal top 560 is preferably a plate-like structure mounted to the top 245 of the second pedestal tube 240. The pedestal top 560 may include an aperture formed therethrough having an aperture diameter and formed about an aperture axis 563, where the aperture diameter is greater than the third pedestal tube outer diameter 261 (and thus also greater than the bearing inner diameter 542). According to an exemplary embodiment, the pedestal top 560 is mounted to the top 245 of the second pedestal tube 240 such that the aperture axis 563 is coaxial with the body axis 205. In such a configuration, the third pedestal tube 260 extends through the aperture of the pedestal top 560. The bearing 540 may then be mounted to the pedestal top 560 with the bearing axis 543 also oriented to be coaxial with the body axis 205, and aperture axis 563. A stationary portion of the bearing 540 may be permanently mounted to the pedestal top 560 via welding or some other means, according to an exemplary embodiment.

To prevent the ring and spur gears 520, 530 from coming into contact with debris, to protect from exposure to environmental elements (e.g., rain, snow, dirt, dust, etc.), and/or to minimize injury or harm to a person, a gear cover 550 may be used. The gear cover 550 may include a top surface 551, a side surface 552, and an aperture. The top surface 551 and side surface 552 are configured to cover the drive train of the rotation assembly 500, namely the ring gear 520, spur gear 530, and shaft 511 of the motor 510, as shown in FIG. 3. According to an exemplary embodiment, the gear cover 550 may be comprised of a thin metal material (e.g. steel, copper, stainless steel or aluminum). The gear cover 550 preferably extends about the third pedestal tube 260 when the gear cover 550 is installed on the body assembly 200 of the sampling system 100. The cover 550 is preferably circumferentially spaced from or gasketed about the third pedestal tube 260 to minimize or eliminate friction therewith.

In other embodiments, greater or fewer than three pedestal tubes 220, 240, 260 may be used. For example, the present invention described herein may also include a fourth pedestal tube configured to mount to the third pedestal tube 260. Likewise, it is contemplated that an embodiment including two pedestal tubes 220, 240 (i.e. omitting the third pedestal tube 260) may be used in the alternative. In embodiments using two pedestal tubes 220, 240, the second pedestal tube 240 is preferably configured to rotate about the coaxial axes 223,243 using a rotation assembly 500 described above. In embodiments using four pedestal tubes (including two pedestal tubes 220,240, as described herein plus a third non-rotatable pedestal tube), the fourth pedestal tube is preferably configured to rotate about the body axis 205 using the rotation assembly 500 described above.

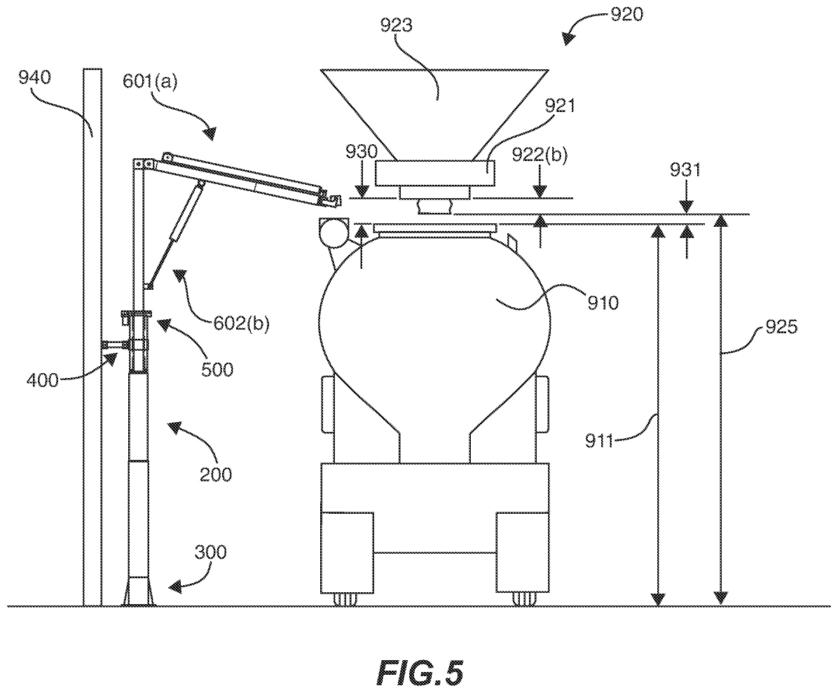

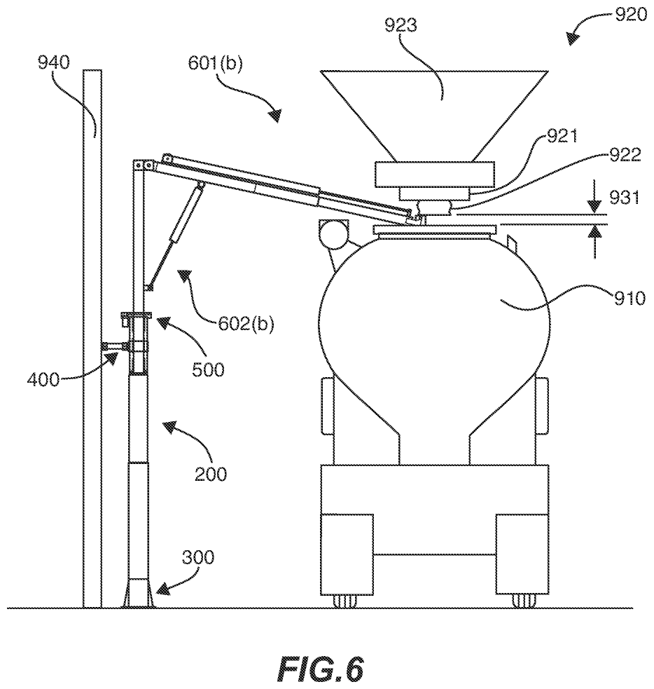

Referring now to FIG. 4, the extension arm assembly 600 of the sampling system 100 is shown. The extension arm assembly 600 may include a first arm 620, a second arm 640, a first cylinder 660, and a second cylinder 670 (shown in a first collapsed position 602(a) and a second extended position 602(b)). The extension arm assembly 600 may be configured to extend the second arm 640 from a retracted position 601(a) (see also FIG. 5) to an extended position 601(b), where a particle mixture sample is taken when the second arm 640 is in the extended position 601(b) (see also FIG. 6). The extension arm assembly 600 may also be configured to rotate in a vertical plane from a lowered position 602(a) (orientation shown in FIG. 1) to an elevated, cantilevered position 602(b) (shown in FIGS. 5 and 6).

The first arm 620 may also extend along a first arm axis 623 for a first arm length 624 and include a pedestal end 625 and an extension end 626. The first arm 620 may also include a first arm body 630, a first cylinder mounting means 631, and a second cylinder mounting means 632. The first arm 620 may be configured as a tubular member having a circular cross-sectional shape and a hollow core. Alternatively, the first arm 620 may include a cross-sectional shape that is square or some other preferably symmetrical shape. The first arm axis 623 preferably extends through a center point of the symmetrical cross-sectional shape along the first arm length 624.

According to exemplary embodiments, the first arm 620 may be tubular over the entire first arm length 624. However, in other embodiments, the pedestal end 625 of the first arm 620 may be closed, or the first arm 620 may have a solid cross-section over a portion of the first arm length 624. The extension end 626, however, must remain open according to exemplary embodiments, to slidably receive the second arm 640 therein. The pedestal end 625 may also feature a radius 625(a) and an extension arm mounting aperture 625(b), which further includes a mounting aperture axis. The radius 625(a) may be configured to permit the unobstructed rotation of the extension arm assembly 600 about the mounting aperture axis. The mounting aperture 625(b) may be configured to accept a fastener in order to rotatably couple the extension arm assembly 600 to the extension arm fixture 270 of the third pedestal tube 260. When the first arm 620 is mounted to the extension arm fixture 270 of the third pedestal tube 260, the extension arm fixture aperture 271 may be substantially coaxial or aligned with the mounting aperture 625(b). In exemplary embodiments, the third pedestal tube 260 is coupled to the first arm 620 by use of a shank-style fastener (e.g., hex bolt) inserted through the coaxial or aligned apertures 271, 625(b) (i.e. the extension arm fixture aperture and the mounting aperture axis of the pedestal end 625 of the first arm 620).

The second arm 640 of the extension arm assembly 600 is formed along a second arm axis 643 for a second arm length 644 and includes a pedestal end 645 and a cup end 646. In addition, the second arm 640 may include a second arm body 650 and a first rod mounting means 651. According to an exemplary embodiment, the second arm 640 may be configured as a tubular member having a hollow core and a circular cross-sectional shape. However, in other embodiments, the second arm 640 may be formed as a solid rod. Alternatively, the second arm 640 may be configured to have a cross-sectional shape that is square or some other symmetrical shape. In whichever embodiment, the second arm 640 may preferably include a cross-sectional shape that is substantially similar to the cross-sectional shape of the first arm 620.

Similarity of cross-sectional shape may be preferred to enhance cooperation of the first arm 620 and second arm 640 because the second arm 640 is preferably slidably received within the first arm 620 (or vice versa). In such embodiments, the inner diameter of one of the first arm 620 and the second arm 640 may be slightly larger than the outer diameter of the other of the first arm 620 and the second arm 640. Where the second arm 640 is received within the first arm 620, the second arm 640 may thus be inserted into the hollow core of the first arm 620. Specifically, the pedestal end 645 of the second arm 640 will be inserted into the extension end 626 of the first arm 620. In such embodiments, the first arm axis 623 will be substantially coaxial with the second arm axis 643, creating a telescoping configuration and an extension axis 605. The telescoping configuration may enable the second arm 640 to translate along the extension axis 605 for the purpose of extending to an extended position 601(b) or retracting to a retracted position 601(a).

The pedestal end 645 of the second arm 640 may be configured as an open end or a closed end. In preferred embodiments, the pedestal end 645 may not need to accommodate the fastening of the second arm 640 within the first arm 620 because the pedestal end 645 is simply disposed within the first arm 620 whether in the extended position 601(b) or in the retracted position 601(a). The cup end 646 of the second arm 640, however, may preferably be configured to accommodate the mounting of the cup assembly 700 to the second arm 640. For example, the cup end 646 may include mounting means 646(a) such as one or more cup mounting apertures configured to accept fasteners, according to an exemplary embodiment. Alternatively, the cup mounting means 646(a) may include a slot or groove configured to accept the cup assembly 700 where the cup assembly 700 will be welded or mated to the cup end 646. In embodiments where one or more cup apertures are used, each aperture may further include cup mounting aperture axis.

Because the first arm 620 and the second arm 640 are coupled in a telescoping fashion, the extension arm assembly 600 may extend or retract to a desired or predetermined orientation, according to the position of the second arm 640, specifically whether the second arm 640 is in the retracted position 601(a), in the extended position 601(b), or some other position.

The first cylinder 660 includes a longitudinally translatable rod 661, a cap end 665, and a rod end 666. The cap end 665 of the first cylinder 660 further includes a cap aperture 665(a) having a cap axis. Likewise, the rod end 666 of the first cylinder 660 may include a rod end aperture and a rod end aperture axis. However, the rod end 666 of the first cylinder 660 may also be comprised as a flat end having no aperture. In such embodiments, the rod end 666 may include some other feature such as a groove or external threads so as to enable to rod end 666 to be fastened to the first rod mounting means 651 of the second arm 640 by some other means, such as a retaining clip or internal threads, respectively.

The second cylinder 670 includes a longitudinally translatable rod 671, a cap end 675, and a rod end 676. The cap end 675 of the second cylinder 670 further includes a cap aperture 675(a) formed about a cap axis. Likewise, the rod end 676 may include a rod end aperture formed about a rod end aperture axis. However, the second cylinder 670 may also include a rotation actuation mounting means 677. Said rotation actuation mounting means 677 may be configured to pivotably couple to the rod end 676 of the cylinder, whilst also providing a pedestal mounting end 698. According to an exemplary embodiment, the pedestal mounting end 698 may be configured to secure to the third pedestal tube 260, whether by use of fasteners, welding, or some other means. This rotation actuation mounting means 677 remains fixed on the outer surface 269 of the third pedestal tube 260 during the rotation of the extension arm assembly 600. Because the rod end 676 is pivotably mounted to the rotation actuation mounting means 677, the angle 679 of the second cylinder 670 with respect to the rotation actuation mounting means 677 is permitted to vary.

To facilitate the extension of the extension arm assembly 600 (i.e. the extension of the second arm 640 relative to the first arm 620) from a retracted position 601(a) to an extended position 601(b) (or vice versa) and to facilitate the raising a lowering of the extension arm assembly 600 (i.e. the pivoting of the extension arm assembly 600 about the mounting aperture axis of the pedestal end 625 of the first arm 620), the first arm body 630 may further include the first cylinder mounting means 631 and the second cylinder mounting means 632, as noted above. According to an exemplary embodiment, the first cylinder mounting means 631 may be configured to couple with the cap end 665 of the first cylinder 660. Likewise, the second cylinder mounting means 632 may be configured to facilitate the coupling of the cap end 675 of the second cylinder 670 to the first arm body 630. In exemplary embodiments, the first cylinder mounting means 631 and second cylinder mounting means 632 of the first arm body 630 may include a first and second cylinder mounting aperture 631(a),632(a), respectively. Said cylinder mounting apertures 631(a),632(a) may be formed about cylinder mounting aperture axes that substantially align with the cap axis of the cap end 665 first cylinder 660 and the cap axis of the cap end 675 second cylinder 670, respectively. This configuration may enable the coupling of the cylinders 660, 670 to the cylinder mounting means 631, 632 via a shank style fastener (e.g., hex bolt), for example.

To further facilitate the extension and retraction of the second arm 640 relative to the first arm 620 (i.e. the translation of the second arm 640 along the extension axis 605), the second arm body 650 may further include the first rod mounting means 651. The first rod mounting means 651 of the second arm body 650 may be configured to couple to the rod end 666 of the first cylinder 660. In some embodiments, the first rod mounting means 651 may be configured as a hole with internal threads configured with accept the external threads of the rod end 666, or alternatively as a pillow block plain or roller bearing. In other embodiments wherein the rod end 666 includes a rod end aperture and a rod end aperture axis, the first cylinder mounting means 652 may include a corresponding cylinder mounting aperture and a cylinder mounting axis. This configuration may enable the coupling of the rod end 666 of the first cylinder 660 to the second arm body 650 by inserting a shank-style fastener (e.g., hex bolt) into the substantially coaxial or aligned apertures of the rod end 666 and first cylinder mounting means 651.

Regardless of the coupling configuration, when the rod end 666 of the first cylinder 660 is coupled to the second arm body 650, the extension of the rod 661 of the first cylinder 660 will subsequently extend the second arm 640 into the extended position 601(b). In the same way, the retraction of the rod 661 of the first cylinder 660 will cause the second arm 640 to retract into the retracted position 601(a). According to an exemplary embodiment, the first cylinder 660 may include a preferred minimum travel distance of fifty-four inches (54″) in order to translate the second arm 640 along the extension axis 605 from the retracted position 601(a) to the extended position 601(b) or vice versa.

The rotation of the extension arm assembly 600 about the mounting aperture axis of the pedestal end 625 of the first arm 620 may be facilitated by the extension and retraction of the second cylinder 670. More specifically, the extension of the second cylinder 670 may be configured to cause the extension arm assembly 600 to rotate into the elevated position 602(b), while the retraction of the second cylinder 670 may be configured to cause the extension arm assembly 600 to rotate into the lowered position 602(b). The rod end 676 of the second cylinder 670 may be coupled to the rotation actuation mounting means 677. The rotation actuation mounting means 677 may be configured to pivotably couple to the rod end 676 of the second cylinder 670, as is described above. In other embodiments wherein the rod end 676 of the second cylinder 670 includes a rod end aperture and rod end aperture axis, the rotation actuation mounting means 677 may include a corresponding cylinder mounting aperture and a cylinder mounting axis. This configuration may enable the coupling of the rod end 676 of the second cylinder 670 to the third pedestal tube 260 by inserting a shank-style fastener (e.g., hex bolt) into the substantially coaxial or aligned apertures of the rod end 676 and rotation actuation mounting means 677, for example.

According to an exemplary embodiment, the second cylinder 670 may include a preferred minimum travel distance of twenty-one inches (21″) in order to rotate the extension arm assembly 600 from the lowered position 602(a) to the elevated position 602(b) or vice versa.

The actuation of the various cylinders 660, 670 to extend or retract the second arm 640 (i.e. from the retracted position 601(a) to the extended position 601(b) or vice versa) or to raise or lower the extension arm assembly 600 (i.e. from the elevated position 602(b) to the lowered position 602(a) or vice versa) may preferably be facilitated by hydraulic, pneumatic, or electric power provided by a corresponding power source. According to an exemplary embodiment, the power source is preferably remotely controlled by a controller 110 operated by a user.

The controller 110 may include a programmable logic controller (“PLC”) programmed to perform a plurality of functions associated with the sampling system 100. According to an exemplary embodiment the controller 110 may command the operation of each of the plurality of functions in a predetermined sequence, which may be in response to sensed conditions. For example, the controller 110 may be programmed to perform the following sequence: (1) rotate the motor 510 (e.g., 90° in a first direction); (2) raise the extension arm assembly 600 from the lowered position 602(a) to the raised position 602(b); (3) extend the extension arm assembly 600 from the retracted position 601(a) to the extended position 601(b); (4) retract the extension arm assembly 600 from the extended position 601(b) to the retracted position 601(a); (5) lower the extension arm assembly 600 from the elevated position 602(b) to the lowered position 602(a); and (6) rotate the motor 510 (e.g., 90° in a second direction where the second direction is opposite the first direction). In such an embodiment, controller 110 may have a button, switch, etc. that may be activated, where said activation commands the performance of the entire predetermined sequence. In other embodiments, each of the steps of the predetermined sequence may be performed independently by the activation of a plurality of buttons, switches, etc. The controller 110 may also control a duration of time for the performance of each of the steps of the predetermined sequence.

While the controller 110 may be a handheld controller, it is contemplated that the controller 110 could also be mounted to, near or remote from the sampler system 100 (e.g., mounted to the body assembly 200 or base assembly 300, or in a control room). In such an embodiment, a user may activate the button, switch, etc. to begin the predetermined sequence as described above, and preferably at least part of the sequence, and preferably all of the sequence, is carried out automatically after activation.

According to an exemplary embodiment, the sampling system 100 may also include a plurality of position sensors in communication with the PLC of the handheld controller 110. The position sensors may be limit switches or proximity sensors adapted to detect the position of the extension arm assembly 600, or portions thereof. Specifically, the position sensors may detect the rotational position of the extension arm assembly 600 as actuated by the rotation assembly 500, such as by detecting a first rotational position and a second rotational position of the third pedestal tube 260. The first rotational position may be the rotational position of the third pedestal tube 260 (and, thus, extension arm assembly 600) when the sampler system 100 is in a home position (e.g., the position before step (1) or after step (6) of the predetermined sequence described above). The second rotational position may be the rotational position of the third pedestal tube 260 (and, thus, extension arm assembly 600) after step (1) and before step (6) of the predetermine sequence, for example.

The position sensors may also detect when the extension arm assembly is in both the lowered position 602(a) and the elevated position 602(b). Likewise, the position sensors may detect when the extension arm assembly is in a retracted position 601(a) and in an extended position 601(b). By detecting these positions, the position sensors may communicate with the PLC of the handheld controller 110 when the sampler system 100 is in a position triggering another step in the predetermined sequence 100. In this way, sampler system 100 may operate in a semi-automated fashion, according to an exemplary embodiment. Specifically, the activation of the button on the handheld controller 110 may cause the extension arm assembly 600 to rotate, raise, and extend (i.e. move to the raised position 602(b) and extended position 601(b)) such that the cup assembly 700 is positioned to receive a particle mixture sample, as is described below.

The position sensors may be contact limit switches adapted to contact a component of the sampler system 100 when the extension arm assembly 600 reaches a certain position (e.g. a tab mounted to the pedestal top 560 that strikes a tab mounted to the third pedestal tube 260 after the third pedestal tube 260 achieves a specified rotation angle). Alternatively, the position sensors may be contactless sensors, such as capacitive proximity sensors adapted to sense the position of some object relative to the sensor without requiring physical contact of the object with the sensor. For example, the proximity sensor may sense the position the extension arm assembly 600 relative to first pedestal tube 220 or second pedestal tube 240 when the extension arm assembly 600 reaches the lowered position 602(a). In either embodiment, the position sensors may communicate, whether via wired or wireless means, with the controller 110 to control the operation of the sampling system 100, or at least provide feedback thereto.

As noted above, the cup assembly 700 is coupled to the cup end 646 of the second arm 640. The cup assembly 700 may further include a cup body 710, and a cup mount body 720. The cup mount body 720 may further comprise an arm mounting end 725 and a cup mounting end 726, where the arm mounting end 725 is configured to couple to the cup end 646 of the second arm 640, and the cup mounting end 726 is configured to pivotably couple (e.g., as a gimbal) to the cup body 710. The cup body 710 may further include a weighted base 715, a mouth end 716, and pivotable mounting means 711. The pivotable mounting means 711 may be configured to pivotably couple to the cup mounting end 726 of the cup mount body 720, according to an exemplary embodiment. When coupled, the cup body 710 may be configured to rotate about the pivotable mounting means 711. In an exemplary embodiment, either the pivotable mounting means 711 or the cup mounting end 726 include an aperture while the other includes a pin. In such embodiments, said aperture is configured to rotatably accept the pin. The pivotable mounting means 711 is preferably closer to the mouth end 716 of the cup body 710 than to the weighted base 715. In any event, the cup body 710 is preferably gimballed with respect to the second arm 640, or with respect to the arm assembly 600, generally.

According to an exemplary embodiment, the weighted base 715 of the cup body 710 is preferably biased in a predetermined orientation by a gravitational bias force 717, such as a gimbal orientation. The gravitational bias force 717 may act to keep the cup in an upright position, where the mouth end 716 is disposed at a predetermined location, such as vertically above (or at least towards the source vessel of the substance to be sampled with respect to) the weighted bottom 715. In such embodiment, the mouth end 716 of the cup body 710 will preferably always be positioned to both accept the particle mixture from a hopper assembly 920 (when the cup body 710 is empty) and to permit the retrieval of the particle mixture from the cup body 710 after a particle mixture sample is taken. To achieve the gravitational bias force 717, the weighted bottom 715 of the cup body 710 may preferably include a substantial mass relative to the rest of the cup body 710, and the mounting end 726 is coupled to the mounting means 711 at a position that is vertically above the center of mass of the cup body 710 when filled with the material to be sampled. Because the cup body 710 may be pivotably mounted to the cup mounting end 726 of the cup mount body 720 and because the weighted bottom 715 may preferably be affected by an ordinary gravitational force (i.e. a force in a downward direction according to Earth's gravitational pull) that exceeds any other forces acting to rotate the cup body 710 in some other direction during normal operation, the cup body 710 will remain upright as the extension arm assembly is rotated or extended.

The cup assembly 700 may receive a sample of a particle mixture, according to the present invention. The cup body 710 may receive particle feed mixture via the mouth end 716. In addition, the cup assembly 700 may include a plastic bag liner (e.g., a plastic zipper bag) or other removable liner. For example, the liner may be inserted into the mouth end 716 of the cup body 710 so that the sample of particle mixture may be easily removed from the cup assembly and an identification label applied thereto.

As is introduced above and depicted in FIGS. 5 and 6, the sampling system 100 may be used to obtain samples of a particle mixture (e.g. animal feed) as the particle mixture is being transferred from a particle mixture source (e.g. feed mill hopper) to a separate mixture vessel 910 (e.g. a delivery truck having a bulk commodity trailer). Specifically, particle mixture may be transferred from a hopper assembly 920 to a delivery truck 910, where the hopper assembly 920 includes a gate 921, a flexible chute 922, and a hopper 923. The gate 921 includes an open position and a closed position, wherein the open position allows particle mixture to flow freely from the hopper 923 through the gate 921, while the closed position prevents the flow of any particle mixture from the hopper 923 through the gate 921. The particle mixture is stored in the hopper 923 and exits through the flexible chute 922 when the gate 921 is in the open position. The flexible chute 922 may be configured to direct the particle mixture from the hopper 923 into the separate mixture vessel 910, such as the trailer of a delivery truck, for example.

The hopper assembly 920 may be mounted above the separate mixture vessel 910. More specifically, the hopper assembly 920 is elevated above a ground surface, and the area underneath the hopper assembly 920 is open and free from permanent structures or obstructions to permit positioning of a separate mixture vessel 910 (e.g., trailer, train car, etc.) underneath the hopper assembly 920. Indeed, the hopper assembly 920 is configured to permit the particle mixture to be deposited into a separate mixture vessel 910 for the purpose of transporting the mixture away from the hopper assembly 920 (and associated feed mill, for example) to some other location.

Because the separate mixture vessel 910 may be configured as one of a plurality of different delivery trucks, train cars, or similar transporting means, the hopper assembly 920 must be elevated from the ground at a sufficient hopper height 925. Because each separate mixture vessel 910 may include a different respective height 911 than another, there exists a differential height 930 between the hopper height 925 and the separate mixture vessel height 911. The hopper assembly 910, therefore, may preferably include a flexible chute 922 to direct the flow of the particle mixture into the separate mixture vessel 910. However, the flexible chute 922 may not be configured to extend from the gate 921 completely into the separate mixture vessel 910 according to an exemplary embodiment. Rather, the flexible chute 922 has a chute bottom 922(a) and a chute length 922(b), where the chute length 922(b) extends only a portion of the differential height 930, thus creating a sampling gap 931 between the chute bottom 922(a) and the separate mixture vessel 910.

The sampling system 100 of the present invention is configured to take a sample of the particle mixture as it passes through the sampling gap 931 (i.e. the void between the bottom 922(a) of the chute 922 and the separate mixture vessel 910). Therefore, the sampling gap 931 is preferably large enough to permit the cup body 710 of the cup assembly 700 to be inserted into the sampling gap 931.

Generally, to use a particle mixture transfer sampling system 100 according to the present invention, a human operator controls the motor 500 and the cylinders 660,670 to position the cup assembly 700 within the path of a transferring mixture. Once a sample of the mixture is received within the cup assembly 700, the operator controls the motor 500 and cylinders 660,670 to return the cup assembly to a location where the sample can be removed from the cup assembly 700 and analyzed, such as by removing the bag liner from the cup body 710. The motor 500 controls the rotation of the third pedestal tube 260 thereby controlling rotational positioning of the cup assembly 700 about the body axis 205. The cylinders 260,270 generally collectively control both the relative height of the cup assembly 700 and the distance of the cup assembly from the body axis 205. Control of electric or hydraulic motors and electric, hydraulic and/or pneumatic cylinders is generally known in the art. As discussed above, the control of the electric or hydraulic motors and electric, hydraulic and/or pneumatic cylinders may also be achieved according to a PLC controller.

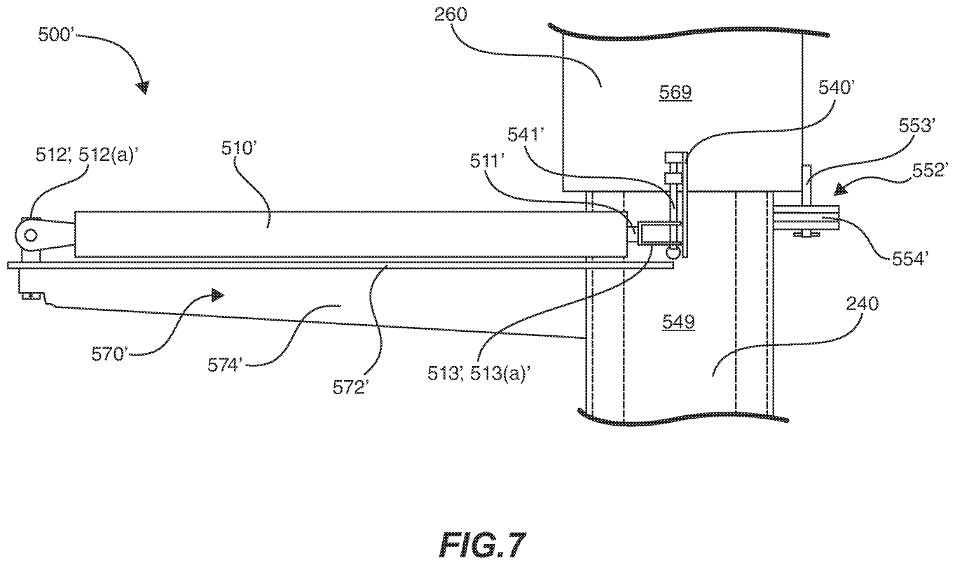

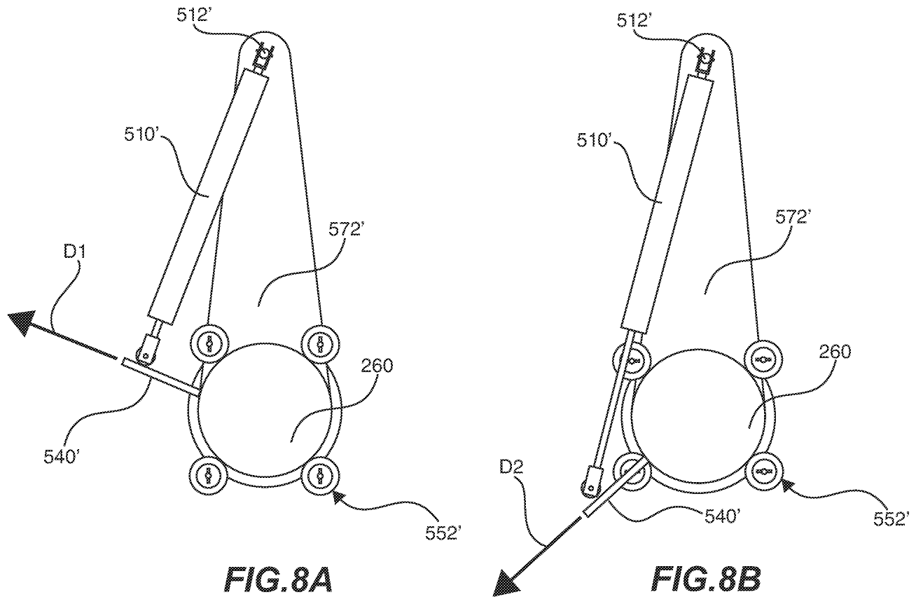

An alternative embodiment 500′ of a rotation assembly is shown in FIGS. 7, 8A, and 8B. The rotation assembly 500′ may include an actuation cylinder 510′ (e.g., a hydraulic, pneumatic, or electric linear actuator) coupled to and situated between a bearing plate 540′ and a cylinder mounting means 570′, such as a shelf 572′, which may be supported by a gusset brace 574′. The rotation assembly 500′ may also include one or more bearing assemblies 552′. The actuation cylinder 510′ includes a longitudinally translatable rod 511′, a cap end 512′, and a rod end 513′. The cap end 512′ of the actuation cylinder 510′ further includes a cap end mounting means 512(a)′, such as a pin joint, that is configured to couple the cap end 512′ of the actuation cylinder 510′ to the cylinder mounting means 570′. Likewise, the rod end 513′ further includes a rod end mounting means 513(a)′, such as a prismatic joint, that is configured to couple the rod end 513′ to the bearing plate 540′.

The bearing plate 540′ may be configured to secure to the outer surface 269 of the third pedestal tube 260, whether by use of fasteners, welding, or some other means. The bearing plate 540′ may further include a plate coupling means 541′ secured to the bearing plate 540′ by fasteners, welding, or some other means. The coupling means 541′ is configured to pair with the rod end mounting means 513(a)′, securing the rod end 513′ to the bearing plate 540′. During the actuation process, the bearing plate 540′ remains fixed on the outer surface 269 of the third pedestal tube 260 throughout the actuation process. The bearing plate 540′ may be made of the same materials as the third pedestal tube 260.

The cylinder mounting means 570′ is preferably secured to the second pedestal tube 240 through the use of fasteners, welding, or some other means. The cylinder mounting means 570′ remains fixed on the outer surface 249 of the second pedestal tube 240 during the actuation process. The cylinder mounting means 570′ may be made of the same materials as the second pedestal tube 240. During the actuation process, the rod 511′ of the actuation cylinder 510′ extends, forcing the bearing plate 540′ away from the actuation cylinder 510′, thereby rotating the third pedestal tube 260 to its turned position (e.g., towards direction D2). When the rod 511′ is retracted, the bearing plate 540′ is pulled toward the actuation cylinder 510′, causing the third pedestal tube 260 to return to its unturned starting position (e.g., towards direction D1). This configuration facilitates rotation of the third pedestal tube 260 when the rod 511′ of the actuation cylinder 510′ is extended or retracted.

The optional one or more bearing assemblies 552′ may each include a bearing member 553′ coupled as an un-rotating axle to a wheel 554′. The bearing member 553′ may be secured to the outer surface 269 of the third pedestal tube 260 through the use of fasteners, welding, or other means, while the wheel 554′ rests against the outer surface 249 of the second pedestal tube 240, such that it can roll along the outer surface 249 during the actuation process of the rotation assembly 500′. This configuration provides for a smoother rotation of the third pedestal tube 260 by preventing the third pedestal tube 260′ from rubbing against the second pedestal tube 240′ during the actuation process.

According to an exemplary embodiment shown in FIGS. 8A and 8B, the rod 511′ of the actuation cylinder 510′ may include a preferred minimum travel distance of sufficient length to rotate the third pedestal tube 260 at least substantially 90 degrees, from the unturned position (e.g., towards D1) to the turned position (e.g., towards D2) or vice versa. The rotation of the third pedestal tube 260 about the body axis 205 may be facilitated by the extension and retraction of the rod 511′ of the actuation cylinder 510′. More specifically, the extension of the rod 511′ may be configured to cause the third pedestal tube 260 to rotate into a turned (e.g., towards D2), while the retraction of the cylinder 510′ may be configured to cause the third pedestal tube 260 to rotate into an unturned position (e.g., towards D1). This actuation process may preferably be facilitated by hydraulic, pneumatic, or electric power provided by a corresponding power source. According to an exemplary embodiment, the power source is preferably remotely controlled by the controller 110 operated by the user, as described in the embodiments above.

While the above discussion is offered with respect to particle mixture, such as in the context of the sampling of animal feed mixture, the present invention may also be used to sample liquids or gels being discharged from a first vessel to a second vessel where some sampling gap 931 exists between the first and second vessel. Indeed, the present invention is advantageous in that it provides a means of sampling a particle mixture or other substance remotely, rather than requiring one to subject oneself to potential harm by sampling the mixture using traditional means (e.g., a hand-held cup or sampling device).

The foregoing is considered as illustrative only of the principles of the invention. Furthermore, because numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A system comprising:
a body assembly having a top member including an arm mount and a lower member supporting the top member;
an arm assembly having a linearly variable arm length extending from a first end coupled to the arm mount to a second free end supporting a cup; and
a controller configured to vary the arm length.

2. A system according to claim 1, wherein the top member is rotatable about a longitudinal body axis.

3. A system according to claim 2, the system further comprising:
a rotation assembly configured to rotate the top member through at least ninety degrees about the longitudinal axis.

4. A system according to claim 3, wherein the rotation assembly is configured to rotate the top member through at least one hundred and eighty degrees about the longitudinal axis.

5. A system according to claim 4, wherein the controller is also configured to at least one of activate and deactivate the rotation assembly.

6. A system according to claim 1, wherein the cup is gimballed with respect to the arm assembly.

7. A system of claim 3, wherein the body assembly further includes a middle member between the top member and lower member, wherein the middle member supports the top member and is supported by the lower member.

8. A system of claim 7, wherein the rotation assembly is disposed about the middle member.

9. A method comprising the steps of:
positioning a cup in a stream of material being transferred from one receptacle to another;
collecting a sample of the material in the cup; and
mechanically translating the cup out of the stream of material.

10. A method according to claim 9, wherein the positioning step comprises the step of:
extending an arm assembly from a retracted position to an extended position, the cup being supported by the arm assembly.

11. A method according to claim 10, wherein the positioning step further comprises the step of:
rotating a body assembly from a storage position through at least ninety degrees to a rotated position, wherein the arm assembly is attached to the body assembly.

12. A method according to claim 11, wherein the translating step comprises the step of:
retracting the arm assembly from the extended position to the retracted position.

13. A method according to claim 12, wherein the translating step further comprises the step of:
rotating a body assembly from a rotated position through at least ninety degrees to a storage position.

14. A method according to claim 9, wherein the cup is gimballed with respect to the arm assembly.

15. A system comprising:
a body assembly having a top member including an arm mount and a lower member supporting the top member, wherein the top member is rotatable about a longitudinal body axis;
a rotation assembly configured to rotate the top member, wherein the rotation assembly comprises a linear actuator;
an arm assembly having a linearly variable arm length extending from a first end coupled to the arm mount to a second free end supporting a cup; and
a controller configured to vary the arm length and rotation of the top member.

16. A system according to claim 15, wherein the linear actuator is a hydraulic linear actuator.

17. A system according to claim 15, wherein the linear actuator is a pneumatic linear actuator.

18. A system according to claim 15, wherein the linear actuator is an electric linear actuator.

19. A system according to claim 15, wherein the rotation assembly further comprises a bearing assembly configured to provide for a smoother rotation of the top member.

20. A system according to claim 15, wherein the body assembly further comprises a middle member disposed between the top member and the lower member, wherein the middle member supports the top member and is supported by the lower member and wherein the rotation assembly is disposed about the middle member.
